(19) United States
(12) Patent Application Publication
(10) Pub. No.: US 2002/0067548 A1
(43) Pub. Date: Jun. 6, 2002

(54) Automobile reflector assembly

(76) Inventor: Artak TerHovhannisian, Burbank, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/991,515

(22) Filed: Nov. 16, 2001

Related U.S. Application Data
(60) Provisional application No. 60/250,940, filed on Dec. 2, 2000.

(51) Int. Cl. G02B 27/10; F21V 7/00

(52) U.S. Cl. 359/627; 362/516; 362/517

(57) ABSTRACT

An automobile reflector assembly includes a reflector having reflective protrusions extending from a reflective surface thereof, and a plurality of light emitting diodes disposed adjacent to the reflective surface. A lens is disposed over the reflector and light emitting diodes. In one form, the lens includes a plurality of domes for reflecting at least a portion of the light emitting from the light emitting diodes onto the reflector so as to disperse the light. The reflector includes a plurality of generally conical depressions underlying each lens dome and surrounding a light emitting diode. In another form, apertures are formed in a circumferential wall of the reflector so as to accept light emitting diodes therethrough in an orientation generally perpendicular to the circumferential wall. The reflector includes a central multi-faceted cone having concave depression formed in each facet, and multiple ridges for directing the light to the lens.

### RELATED APPLICATION

This application claims priority from provisional application Serial No. 60/250,940, filed Dec. 2, 2000.

### BACKGROUND OF THE INVENTION

The present invention generally relates to lights and reflector assemblies. More particularly, the present invention relates to an LED and reflector assembly for use in clearance and safety lights for heavy duty vehicles, commercial trucks and truck trailers, boat trailers, busses, recreational vehicles and other vehicles.

Vehicle warning and safety light assemblies are typically equipped with conventional filament light bulbs which have a number of well-known problems. For example, the light bulbs draw excessive current. Under certain conditions are not bright enough to see from a trailing vehicle. Moreover, traditional light bulbs have a relatively short life span, requiring frequent replacement. Failure to replace such light bulbs promptly can create an unsafe vehicle condition, and possible injury not only to those within the vehicle but also to persons in other vehicles as well.

Light emitting diodes (LED's) have recently been developed for use as a light source in motor vehicle light assemblies. An advantage to using LED's is that they typically have an operating life of as much as 100,000 hours before they begin to degrade. LED's also draw less current from the vehicle's electrical system and emit more light than similarly configured or styled filament light bulbs. LED lighting assemblies have also been found to have better visibility in fog and bad weather and reduce the reaction time during braking. The light emitted from the LED is sharper, brighter and has better visibility from a distance.

However, existing LED light assemblies have been found to have certain disadvantages. The light produced by LED's is a directional light, like a laser beam, with a given specific angle. Currently, LED's are clustered tightly together to achieve a uniform light. These cluster assemblies aggregate the LED's in a position which allows the assembly to pass Department of Transportation light output requirements when viewed from a “top” angle. These assemblies use flat lens or covers which affects the viewing angle. If the viewing angle is changed or the LED is improperly positioned, insufficient light is emitted. Such LED assemblies are covered with a lens, typically red or amber in color. In some models, there is no use of optics whatsoever and the lens is merely a cover for protection.

Such LED clusters have been found to be expensive to produce due to the high number of LED's required. Also, the high number of LED's create an enormous amount of heat which prematurely degrades the life span of such assemblies. To date, there has been no use of reflectors or reflective surfaces to enhance the light output of LED assemblies due to the fact that the train of thought in the industry is that the use of reflectors or reflective surfaces is impractical or ineffective due to the directional light emitted from the LED.

Accordingly, what is needed is an LED assembly which requires fewer LED's. What is also needed is an LED assembly which incorporates an effective reflector to enhance the light output of the assembly. The present invention fulfills these needs and provides other related advantages.

### SUMMARY OF THE INVENTION

The present invention resides in an automobile reflector assembly which is configured to allow the use of only a few LED's in each light assembly.

The assembly generally comprises a reflector having a plurality of reflective protrusions extending from reflective surface thereof. A plurality of light emitting diodes are disposed adjacent to the reflective surface, typically extending through apertures of the reflector. A lens is disposed over the reflector and light emitting diodes. The lens may be of a red or amber color, or transparent when the light emitting diodes emit red or amber light. A base is attached to the lens and with the lens cooperatively houses the light emitting diodes, the reflector and circuitry associated with the light emitting diodes.

In a first embodiment, the lens includes a plurality of domes for reflecting at least a portion of the light emitted from the light emitting diodes to the reflector so as to disperse the light. Each dome includes a central dimple lens and ridges spaced from one another and encircling the central dimple lens in a concentric fashion for directing the light onto the reflector. The reflector includes a plurality of generally conical depressions underlying each lens dome, and surrounding a light emitting diode or a cluster of light emitting diodes. The conical depressions preferably have a width selected to be less than the angle of illumination of the light emitting diode or cluster of light emitting diodes. Each conical depression includes a plurality of protrusions, such as hemispherical bumps, extending from a surface of the conical depression and arranged to maximize a reflective surface of the reflector.

In a second embodiment, the reflector apertures are formed in a circumferential wall of the reflector and configured to accept the light emitting diode therethrough in a orientation generally perpendicular to the circumferential wall. The reflector includes a central multi-faceted cone having a concave depression formed in each facet. Each concave depression is generally aligned with a light emitting diode for directing light from the light emitting diode to the lens above the reflector. Preferably, the facets of the cone are directed at a approximately 45 degree angle with respect to the light emitting diode directed thereat.

The reflector also includes multiple ridges extending upwardly from an interior surface thereof at approximately 45 degree angles with respect to the light emitting diodes for directing the light emitted from the light emitting diodes to the lens. These ridges include base ridges descending in stepped fashion from the aperture to the cone, and partition ridges which are elevated with respect to the base ridges and descend in step fashion from the circumferential wall towards the cone. Preferably, the base ridges include dimples or bumps thereon for further dispersing the light from the light emitting diode. The lens in this embodiment does not necessarily include special optics, and may be of a standard and flat lens variety.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of an automobile reflector assembly embodying the present invention;

FIG. 2 is an exploded perspective view of the assembly of FIG. 1;

FIG. 3 is a cross-sectional view taken generally along line 3-3 of FIG. 2, illustrating a lens configuration used in accordance with the present invention; and

FIG. 4 is an exploded perspective view of another automobile reflector assembly embodying the present invention.

### DETAILED DESCRIPTION OF THE PREFERRED EMBODIMENTS

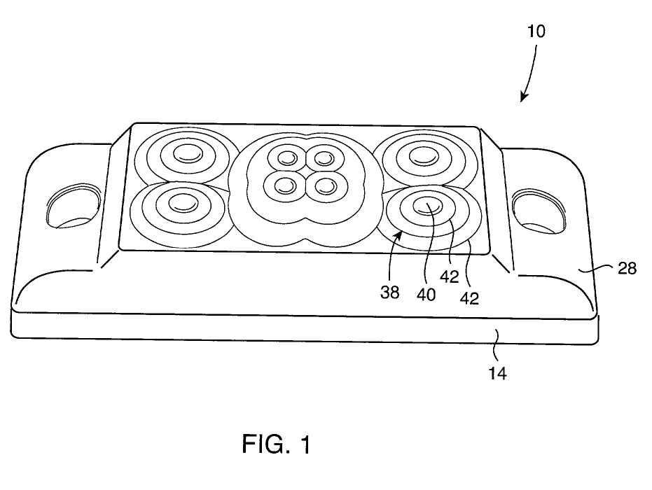

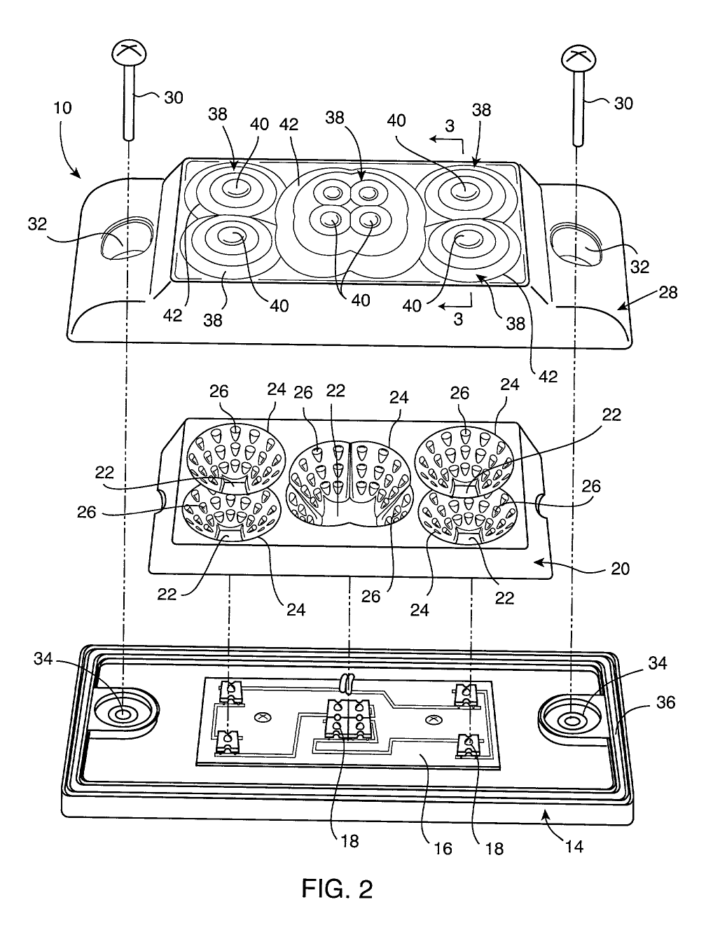

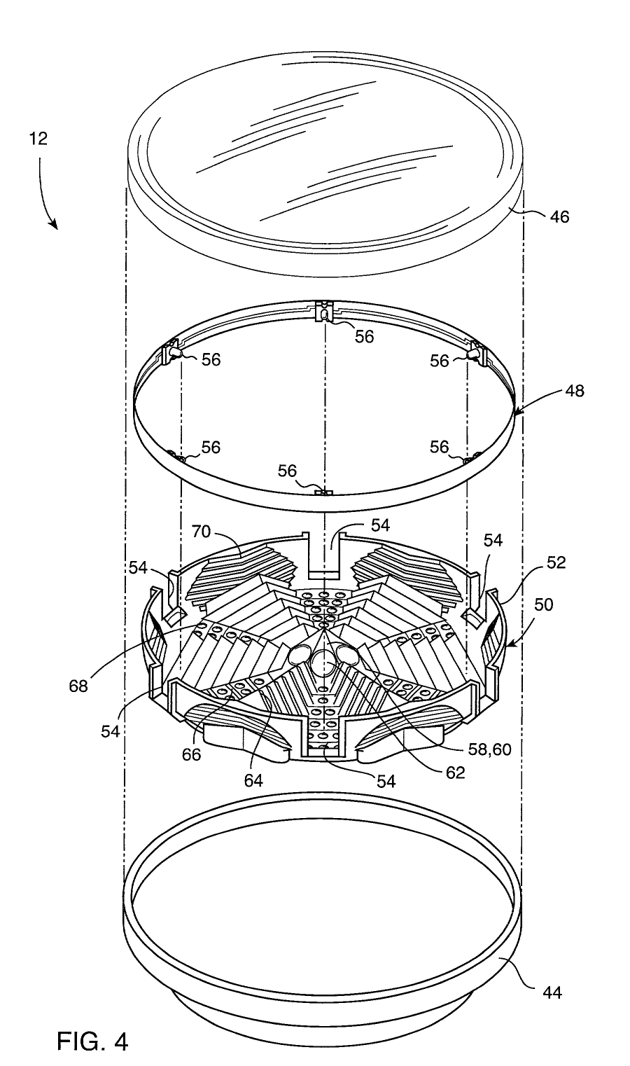

As illustrated in the accompanying drawings for purpose of illustration, the present invention resides in an automobile reflector assembly referred to by the reference number 10 and FIGS. 1 and 2, and by the reference number 12 in FIG. 4. The design of the present invention is so effective that in some models, the number of LED's required for each assembly is only one quarter of those required in existing LED cluster models.

With reference to FIGS. 1 and 2, a first automobile reflector assembly 10 embodying the present invention is shown. The assembly 10 includes a base 14 in which rests a circuit board 16 having a plurality of LED's 18. It will be noted that the LED's 18 are not aggregated in a cluster, but rather spread across the surface of the circuit board 16. The number of LED's 18 in each grouping depends upon the nature of the lighting assembly 10, as larger assemblies and those which require more light emission will include more LED's 18, whereas smaller assemblies will require less. Regardless, the number of LED's 18 required for the present invention is substantially less than that used in current models. The base 14 may be filled with an epoxy that holds the circuit board 16 in place, and serves to direct heat away from the LED's 18. Due to the low number of the LED's 18, neither a heat sink nor such epoxy has been found to be necessary, however.

A reflector 20 is disposed over the LED's 18. The reflector 20 includes a plurality of apertures 22 which are sized to accept each LED 18, or grouping of LED's 18, therethrough so that the LED's 18 are disposed adjacent to reflective surfaces of the reflector 20. The reflector 20 is configured such that a generally conical depression 24 surrounds each light LED or cluster of LED's 18. The inner reflective surface of these conical depressions 24 have a nonuniform reflective surface. More particularly, each conical depression 24 includes a plurality of protrusions 26, typically hemispherical bumps, which are arranged to maximize the reflective surface of the reflector 20. Preferably, each conical depression 24 has a width, or angle, selected to be less than an angle of illumination of the LED or cluster of LED's 18 so light reflection and dispersion is facilitated.

A lens 28 is disposed over the reflector 20 and light emitting diodes 18, and attaches to the base 14, such as by the illustrated bolts 30, so as to house the circuit board 16, LED's 18 and reflector 20. The bolts 30 extend through apertures 32 and 34 of the lens 28 and base 14, respectively, and into corresponding apertures of the vehicle to hold the assembly 10 in place on the vehicle. The lens 28 can also be fixed to the base 14, such as by adhesives or the like. A gasket 36 can be placed between the lens 28 and base 14 to prevent water and other corrosive materials from entering into the assembly 10.

The lens 28 is preferably comprised of ultraviolet stabilized Lexan or other appropriate glass or plastic material. The lens 28 includes multiple dome-like bubbles 38 which overlie each conical depression 24 and LED 18 or grouping of LED's 18. Each dome 38 includes a central dimple lens 40, or several dimples lenses 40 corresponding to each LED 18. For example, the lens 28 illustrated in FIG. 2 includes a large central dome 38 having four dimple lenses 40 corresponding with the grouping of four LED's 18 disposed in the central conical depression 24. The surrounding domes 38 only include one central dimple lens 40 each, which corresponds with a single LED 18 positioned thereunder.

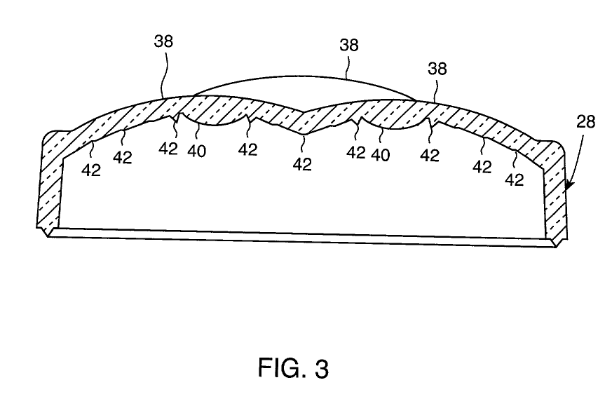

With reference now to FIG. 3, a cross-sectional view of the domed lens 28 is shown. As can be seen from this illustration, the domes 38 arch above the otherwise planar surface of the lens 28. Each central dimple lens 40 extends downwardly into the assembly 10. Each dome 38 includes ridges 42 which encircle each dimple lens 40 in a concentric fashion so that each ridge 42 is spaced from the adjoining ridge. The dimple lens 40 and ridges 42 are intended to reflect the light emanating from the LED back into the assembly 10 and onto the reflector 20. The bumps 26 protruding from the surface of the conical depressions 24 redirect the reflected light back through the lens 28 so as to simulate the look of multiple LED's 18 and effectively disperse the light. This results in the lens 28 effectively glowing due to the redirected, reflected, and dispersed LED light. Thus, very few LED's 18 are required to illuminate the lens 28.

The dome configuration of the lens 28 also significantly increases the overall strength of the lens 28 so that it resists breakage. Such breakage typically occurs in conventional automobile lights when the automobile strikes another object, such as another car, or loose objects on the road strike the lenses. As can be appreciated by the reader, this significantly impacts the safety of the vehicle.

The Department of Transportation regulations that were written in the 1970's, and updated in the 1980's, to require that the color of light emanating from such tail, clearance marker, or automobile signal lights be red or amber depending on the light. The present invention contemplates using LED's 18 which emit red, such as for tail lights, or amber, for side marker lights. The lens 28 can thus be clear. While this may desirable for cosmetic purposes, it also serves as a safety feature. For example, if the battery goes dead and the lights are inoperable, light from a trailing vehicle will enter and exit through the clear lens and be reflected from the reflector of the assembly 10 much easier than through a red or amber lens.

With reference now to FIG. 4, another automobile reflector assembly 12 embodying the present invention is illustrated. The assembly 12 includes a base 44 which cooperates with a lens 46 to house a ribbon of LED's 48 and a reflector 50. The assembly 12 in this embodiment is typically round, although it is conceivable that other configurations could also be employed in the invention. The lens 46 in this embodiment can be a traditional, relatively flat and planar lens as used in current models. Of course, for esthetic appeal and further light dispersion, the lens 28 described above could also be employed.

The reflector 50 is of a bowl or disc-shape and includes a circumferential wall 52 having spaced-apart apertures 54 formed therein. A strip 48 having LED's 56 attached to a flexible, conductive ribbon, such as copper ribbon, is used in this assembly 12. Each LED 5 is directed into the circular strip 48 and spaced from one another so as to correspond with the apertures 54 of the reflector 50. The flexible strip 48 is sized so as to encircle the circumferrential wall 52 of the reflector 50, and dispose an LED 56 into each aperture 54 of the reflector 50, so that each LED is oriented generally perpendicular to the circumferential wall 52. There is no circuit board, rather the LEDS 56 are crimped onto two flat copper strips of about 0.25″ in width, and the ribbon wrapped around the perimeter of the reflector 50 so that the LEDS 56 extend through the apertures 54.

A cone 58 is disposed in the center of the reflector 50 and includes a facet 60 facing each aperture 54. Each facet 60 includes a concave depression 62 which is substantially aligned with each LED 56. Each facet and depression 60 and 62 are preferably formed at a 45 degree angle.

The interior reflective surface of the reflector 50 is non-uniform and includes a plurality of ridges and dimples which serve to reflect and disperse the light emitted from each light emitting diode 56. More particularly, the reflector 50 includes base ridges 64 descending in stepped fashion from the circumferential wall 52 between each aperture 54 to the cone 58. The partition ridges 64 are also formed at a 45 degree angle with respect to the LED's 56 to optimize reflection and dispersion of light. The reflector 50 also includes base ridges 66 which descend in stepped fashion from each aperture 54 to the cone 58. Preferably, the base ridges 66 include a plurality of dimples 68, or other irregular surface, so as to reflect the light emitted from the light emitting diodes 56. The partition ridges 64 are elevated with respect to the base ridges 66. Each base ridge area 66 and adjoining partition ridges 64 form an angle which is preferably less than the light spread of the LED 56. For example, LED's typically have a light spread or splay of approximately 100 degrees. Thus, the area between the partition ridges 64 and base ridges 66 would be preferably less than 100 degrees in order to effectively reflect an disperse light. Other ridges 70 can be formed along the circumferential wall 52 as the need dictates. These ridges 70 preferably also have 45 degree angles.

Thus, as light is emitted from the light emitting diode 56, a central portion of the light will strike the concave depression 62 and facet 60 of the cone 58 and be directed upwardly through the lens 46. Outer portions of the ray of light will encounter the angle partition ridges 64, base ridges 66 and dimples 68 and be directed upwardly through the remainder of the lens 46. Light which is not immediately reflected upwardly through the lens 46 is subsequently reflected by the partition ridges 64 and 66 and dimples 68 and eventually exit through the lens 46. Thus, 100% of the light from the ray emitted by the LED 56 is reflected and dispersed through the lens 46 in a non-focused manner. This allows the use of as few as six LED's 56 in a four inch circular lens assembly 12. By contrast, existing four inch auto light assemblies incorporating LED's require up to sixty-two LED's to effectively light up the assembly.

The present invention provides many advantages over existing LED cluster lighting assemblies. The assemblies 10 and 12 of the present invention are considerably less expensive than existing assemblies due to the fact that fewer LED's are required. Although the assemblies 10 and 12 use fewer LED's, there is an overall increase in the amount of uniform light emitted from the assembly 10 or 12 due to the use of the reflector 20 or 50, and the dome-like lens 28. The reflector 20 and 50 and lens 28 also increase the viewing angle of the light from the assembly 10 or 12, such that visibility is seen from a side angle of the assembly 10 or 12, and not only at a direct angle of the assembly.

Although several embodiments have been described in detail for purposes of illustration, various modifications may be made without departing from the scope and spirit of the invention. Accordingly, the invention is not to be limited except as by the appended claims.

What is claimed is:

1. An automobile reflector assembly, comprising:
a reflector having a plurality of reflective protrusions extending from a reflective surface thereof;
a plurality of light emitting diodes disposed adjacent to the reflective surface;
a lens disposed over the reflector and light emitting diodes; and
a base attached to the lens and with the lens cooperatively housing the light emitting diodes, the reflector and circuitry associated with the light emitting diodes.

2. The assembly of claim 1, wherein the reflector includes a plurality of apertures through which extend the light emitting diodes.

3. The assembly of claim 1, wherein the lens includes a plurality of domes for reflecting at least a portion of light emitting from the light emitting diodes onto the reflector so as to disperse the light.

4. The assembly of claim 3, wherein the domes each include a central dimple lens for directing the light onto the reflector.

5. The assembly of claim 4, wherein the domes each include ridges spaced from one another and encircling the central dimple lens.

6. The assembly of claim 3, wherein the reflector includes a plurality of generally conical depressions underlying each lens dome and surrounding a light emitting diode or a cluster of light emitting diodes.

7. The assembly of claim 6, wherein the conical depressions have a width selected to be less than an angle of illumination of the light emitting diode or cluster of light emitting diodes.

8. The assembly of claim 6, wherein each conical depression includes a plurality of protrusions extending from a surface thereof.

9. The assembly of claim 8, wherein the protrusions comprise hemispherical bumps arranged to maximize a reflective surface of the reflector.

10. The assembly of claim 2, wherein the reflector apertures are formed in a circumferential wall of the reflector and configured to accept a light emitting diode therethrough in an orientation generally perpendicular to the circumferential wall.

11. The assembly of claim 10, wherein the reflector includes a central multi-faceted cone having a concave depression formed in each facet generally aligned with a light emitting diode for directing light from the light emitting diode to the lens.

12. The assembly of claim 11, wherein the facets of the cone are directed at an approximately forty-five degree angle with respect to the light emitting diode.

13. The assembly of claim 10, including multiple ridges extending upwardly from an interior surface of the reflector at approximately forty-five degree angles with respect to the light emitting diodes for directing the light emitted from the light emitting diodes to the lens.

14. The assembly of claim 13, wherein the multiple ridges comprise base ridges descending in stepped fashion from the aperture to the cone, and partition ridges being elevated with respect to the base ridges and descending in stepped fashion from the circumferential wall towards the cone.

15. The assembly of claim 14, wherein the base ridges include dimples formed therein for further dispersing the light.

16. The assembly of claim 1, wherein the lens is transparent and the light emitting diodes emit red or amber light.

17. An automobile reflector assembly, comprising:
a reflector including a plurality of generally conical depressions, each conical depression having reflective protrusions extending from a reflective surface thereof;
a plurality of light emitting diodes disposed within the conical depressions of the reflector;
a lens disposed over the reflector and light emitting diodes, the lens including a plurality of domes, each dome overlying a conical depression of the reflector for reflecting at least a portion of light emitting from the light emitting diodes onto the reflector so as to disperse the light; and
a base attached to the lens and with the lens cooperatively housing the light illuminating diodes, the reflector and circuitry associated with the light illuminating diodes.

18. The assembly of claim 17, wherein the domes each include a central dimple lens for directing the light onto the reflector, and ridges spaced from one another and encircling the central dimple lens.

19. The assembly of claim 17, wherein the conical depressions have a width selected to be less than an angle of illumination of the light emitting diode or cluster of light emitting diodes.

20. The assembly of claim 17, wherein the protrusions comprise hemispherical bumps arranged to maximize a reflective surface of the reflector.

21. The assembly of claim 17, wherein the lens is transparent and the light emitting diodes emit red or amber light.

22. An automobile reflector assembly, comprising:
a reflector having a plurality of apertures formed in a circumferential wall thereof;
light emitting diodes extending through the apertures of the reflector so as to be oriented generally perpendicular to the circumferential wall;
a lens disposed over the reflector and light emitting diodes; and
a base attached to the lens and with the lens cooperatively housing the light illuminating diodes, the reflector and circuitry associated with the light illuminating diodes;
wherein multiple ridges extend upwardly from an interior surface of the reflector at approximately forty-five degree angles with respect to the light emitting diodes for directing the light emitted from the light emitting diodes to the lens.

23. The assembly of claim 22, wherein the reflector includes a central multi-faceted cone having a concave depression formed in each facet generally aligned with a light emitting diode for directing light from the light emitting diode to the lens.

24. The assembly of claim 23, wherein the facets of the cone are directed at an approximately forty-five degree angle with respect to the light emitting diode.

25. The assembly of claim 22, wherein the multiple ridges comprise base ridges descending in stepped fashion from the aperture to the cone, and partition ridges being elevated with respect to the base ridges and descending in stepped fashion from the circumferential wall towards the cone.

26. The assembly of claim 25, wherein the base ridges include dimples formed therein for further dispersing the light.

27. The assembly of claim 22, wherein the lens is transparent and the light emitting diodes emit red or amber light.
